(19) United States
(12) Patent Application Publication
(10) Pub. No.: US 2011/0121745 A1
(43) Pub. Date: May 26, 2011

(54) Modified Alternating Current Operation of a High-Pressure Discharge Lamp

(76) Inventors: Knut Grothmann, Berlin (DE); Ulrich Hartwig, Berlin (DE)

(21) Appl. No.: 13/054,619

(22) PCT Filed: Jul. 15, 2008
(86) PCT No.: PCT/EP08/59210

§ 371 Date: Jan. 18, 2011

(51) Int. Cl. H05B 41/16

(52) U.S. Cl. 315/246

(57) ABSTRACT

A method for operating a high pressure discharge lamp with an alternating current, comprising providing the alternating current with a DC component differing from zero.

### TECHNICAL FIELD

The invention relates to alternating current operation for non-horizontal operating positions of a high pressure discharge lamp.

### PRIOR ART

High pressure discharge lamps are known per se. They are employed for the most varied purposes of use and are operated in the process in different positions.

### SUMMARY OF THE INVENTION

The invention is based on the problem of specifying an improved type of operation for high pressure discharge lamps which enables the latter to be used even more effectively for variable applications. At the same time, the aim is to specify a correspondingly improved electronic ballast, a luminaire equipped therewith, and a use of the ballast.

To this end, the invention is directed to a method for operating a high pressure discharge lamp with an alternating current, characterized in that the alternating current has a DC component differing from zero.

The invention is further directed to an electronic ballast that is designed for operating the lamp with this method, and to a luminaire that has such an electronic ballast.

Furthermore, the invention is directed to the use of this electronic ballast.

Preferred refinements of the invention are specified in the dependent claims and also furthermore emerge from the following description. Here, a distinction is made in detail between features of method and features of device as regards the invention, and so the following disclosure is to be understood with regard to these two categories and the use.

The inventors have proceeded from the fact that in the case of high pressure discharge lamps, electrodes are heated with different intensity when the lamp is, for example, operated in an operating position deviating from the horizontal, or the lamp, in particular the electrodes, is or are not symmetrically constructed for specific reasons. A temperature difference between electrodes can lead, on the one hand, to a disturbed lamp operation, for example flickering, flicker phenomena and arc jumps and, on the other hand, to an accelerated wear of the more intensely heated electrode.

The idea of the invention resides in a suitable operating method for high pressure discharge lamps by means of which the temperature difference of the electrodes can be reduced, in particular also without modifying the design of the lamp.

According to the invention, to this end a high pressure discharge lamp is operated with an alternating current that has a DC component differing from zero. Consequently, one of the two electrodes is operated more intensely as an anode, and therefore the other electrode is operated more intensely as a cathode.

The DC component of the alternating current is defined by the ratio of the integral of the current intensity over a period length to the integral of the absolute value of the current intensity over the same period length. The DC component can therefore assume values of between −1 and +1 or −100% and +100%, and therefore constitutes a measure for effective, directionally dependent charge transport of the alternating current.

Since the polarity of a high pressure discharge lamp in the case of alternating current operation is not prescribed, a polarity reversal of the lamp corresponds to an operating position of the lamp rotated by 180°. In this sense, it suffices to discuss DC components of between 0 and 1, since DC components between −1 and 0 then correspond to an inverted polarity of electrodes.

In that phase of the alternating current operation in which an electrode is operated as a cathode, energy is extracted from said electrode by the exit of the electrons from the electrode material on the basis of the work function, and fed to the other electrode, which is then an anode. Thus, the inventive method raises the temperature of the electrode operating in amplified fashion as an anode, and correspondingly lowers the temperature of the other electrode.

In order to reduce a temperature difference between electrodes by changing the DC component during operation of the lamp in a targeted fashion, there is thus a need to amplify the operation of the colder electrode as an anode, and to amplify the operation of the second electrode as a cathode.

Since the energy transport described is, in particular, determined by the number of the exiting electrons, an amplified anode operation can therefore signify a longer operation in time of the electrode as an anode, or else an on average higher current intensity during the anode operation, or both at the same time. The inventive DC component can therefore be set by a suitable pulse duty factor, differing from 0.5, of the alternating current and/or by an offset of the current, that is to say a superposed direct current. In this case, the current curve can assume any desired time profile, preference being given to rectangular current curves, but trapezoidal, sawtooth or sinusoidal current curves are also possible. A DC component solely as a consequence of the pulse duty factor is preferred.

In particular, owing to the method the temperature difference of the electrodes can be kept smaller than in the case of symmetric alternating current operation. The service life of the lamp can be lengthened owing to the reduced temperature of the hotter electrode, and owing to the raising of the temperature of the colder electrode of the lamp operation, in particular the light output, can be stabilized, and the dimming range of the lamp can also be widened. Likewise, lamps with electrodes of different design can be operated in a way corresponding to the invention, and a lowering of the temperature difference can optionally be attained in this case. In particular, a reduction in the temperature difference can also be effected during lamp operation even in the case of lamps whose electrodes exhibit differences based on manufacturing tolerances.

If a lamp is operated in a non-horizontal operating position, the electrode lying further above is stronger during operation of the lamp than the electrode lying deeper, if the DC component is zero. The temperature difference is greater the greater the angle of the operating position to the horizontal. The invention therefore preferably is directed, in a fashion sequentially increasing, to operating positions that enclose at least an angle of 10°, 30° or 60° and, particularly preferably approximately 90°, with the horizontal.

A compensating DC component can, in a fashion increasing in this sequence, be greater than 0.1, 0.2 or 0.3, and less than 0.8, 0.6 or 0.5. With increasing angle of the operating position to the horizontal, the absolute value of the DC component can be enlarged and, for example, the lower temperature of the electrode lying deeper can be equalized by an amplified anode operation. The DC component must in this case be greater the more strongly the operating position deviates from the horizontal, and/or the stronger further influences, causing a temperature difference, are for example the electrode shape, the design of the lamp housing, the installed situation of the lamp, or an asymmetric cooling of the light. A suitable DC component can be determined in advance and then taken into account in terms of circuitry in an electronic ballast electronically stored or otherwise recorded.

It is conceivable in this case that the ballast has an input device for the DC component, or else an input device for an item of information on the operating position of the lamp respectively being operated, in the latter case the ballast selecting a DC component matching the input operating position. The input at the ballast can, by way of example, be performed in this case manually or via an electrical or electronic signal. Here, the input information can also be buffered, preferably permanently stored, in order to select the DC component even after the instant of the inputting. Also likewise conceivable are a continuous signal sequence, or else a continuous signal at least during the lamp operation, for example in the event of (quasi) continuous changes in operating position.

Furthermore, it is possible to conceive luminaires for high pressure discharge lamps with an inventive electronic ballast, in the case of which the operating position of the lamp can change between two start-ups, or else during ₜhe lamp operation. Thus, the luminaire can, by way of example, have a device for a rotary or swiveling movement, or be fastened on such a device. The luminaire can likewise be freely movable, or be fitted on a freely movable device, for example as a torch or luminaire on a building site vehicle. Such luminaires with (moving) high pressure discharge lamps can preferably also be used for floodlighting on stages or in television studios, and in this case also have an optical assembly for example for focusing the light or else for producing special light effects.

The luminaire can be designed in this case to determine the respective operating position and to adapt the DC component of the alternating current appropriately in that the electronic ballast sets a respectively advantageous DC component by using an item of information relating to the respective operating position, or receives from another side an item of information for an appropriately suitable DC component. Thus, in the event of a change in operating position the new information relating to the position can be transferred (at least once) to the electronic ballast via the input device, or else be transmitted (quasi) continuously. Here, the operating position can be determined, for example, by position, rotary or inclination switches, position, rotary or inclination transmitters or position, rotary or inclination sensors, and ultimately converted into an appropriate DC component. It would also be possible to measure the temperatures at or in the vicinity of the lamp ends and use them appropriately.

### BRIEF DESCRIPTION OF THE DRAWING

The invention is to be explained below in more detail with the aid of an exemplary embodiment, in the drawing,

FIG. 1 shows, a graph of the electrode temperatures as a function of the DC component, and

FIG. 2 shows a luminaire with a movable high pressure discharge lamp.

### PREFERRED EMBODIMENT OF THE INVENTION

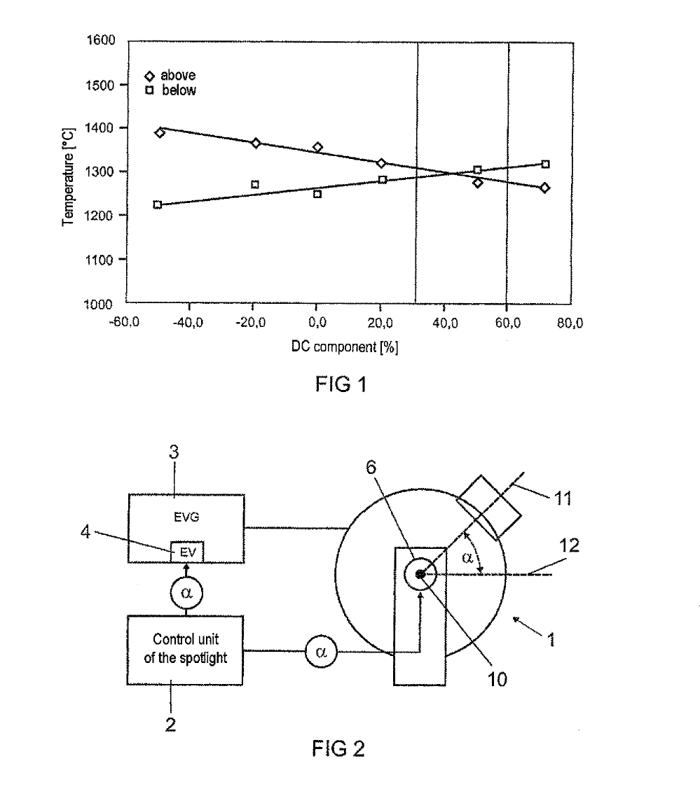

FIG. 1 shows the temperature of the two electrodes, of an identical design, of a metal halide high pressure discharge lamp of the OSRAM HSD150 type, as a function of the DC component of the alternating current with the aid of which the lamp is operated at an electric power of 150 W.

For the measurement illustrated in FIG. 1, the lamp is operated in a vertical operating position such that one of the two electrodes in the lamp vessel is arranged above the other. The DC component is varied for the measurement via a signal input of the electronic ballast with the operating position unchanged. The alternating current has a rectangular current profile, and the DC compohent is set via the pulse duty factor ratio. It is therefore correlated here with the time component of the cathode operation situated above.

The temperature of the electrode lying above is illustrated in the figure by diamonds, and the temperature of the electrode situated below is illustrated by squares. The regression lines are additionally drawn in for illustrative purposes.

It is plain from the figure that when operated conventionally in a vertical operating position with a DC component of zero, that is to say in the case of symmetric alternating current operation, the lamp has a clear temperature difference of approximately 200° C. for the electrodes.

On consideration of the temperature profile of the electrodes over the measured range of the DC component of approximately −50% to +70% it is plainly indicated that it is possible for the invention to influence the temperature difference in a targeted fashion by the DC component of the alternating current. The temperature difference can thus be raised via a DC component of less than zero, that is to say in the case of a predominantly anode operation of the electrode situated at a higher level, something which is, however, not desired here. Rather, the temperature difference is preferably reduced, this being achieved with an enlargement of the DC component to about zero, that is to say a predominantly cathode operation of the electrode situated at a higher level. The temperature difference of the two electrodes vanishes for a DC component of approximately 40% such that this DC component can be regarded as optimal for the lamp used here in the test environment. If the DC component is enlarged beyond 40%, it is possible, although not preferred, for a cooling of the electrode situated above also to be achieved by comparison with the electrode situated below.

Thus, the invention enables the operation of lamps in any desired operating position, including in operating positions that deviate only slightly from the horizontal and that, in particular, require a DC component of virtually zero. However, the invention is particularly advantageous for vertical operating positions in the case of which a particularly high temperature difference would be set during conventional operation; as the figure shows, said temperature difference can be very effectively compensated by a DC component (of possibly 40% for the measured lamp).

It is, furthermore, conceivable for the lamp to be operated in a fashion rotated by 180°. As previously described, it would then be necessary to invert the polarity of the electrodes, or to select an inverse DC component, for example −40% instead of 40%. These two measures correspond to one another in the sense of the invention such that only DC components of between 0 and 100% are considered in the description and in the claims.

FIG. 2 shows a luminaire with a rotatable spotlight 1 that is designed for floodlighting on stages and in television studios. The spotlight 1 can be rotated with the aid of a motor drive 6 about an axis 10 perpendicular to the plane of the drawing. Use is made as light source of a high pressure discharge lamp (not illustrated for reasons of clarity) that is mounted in the spotlight, that is to say in a fashion rotatable therewith. In order to focus the light, the spotlight 1 has an optics assembly 5, and can emit a light beam in rotary position 11 at an angle α to the horizontal 12. Here, the operating position of the high pressure discharge lamp is likewise aligned along the rotary position 11, that is to say its electrode spacing is inclined by the angle α to the horizontal 12. A rotation of the spotlight in relation to the horizontal then also effects such a rotation of the operating position of the high pressure discharge lamp.

Here, a control unit 2 prescribes the position angle α of the motor drive 6, that is to say the rotary position 11 of the spotlight, and transmits said position angle by means of an electronic signal to an electronic ballast (EVG) 3 of the high pressure discharge lamp. To receive the signal, the electronic ballast 3 has an input device 4 for an item of operating position information, the control unit 2 transmitting the position angle α as an item of operating position information during operation of the luminaire in short periodic time intervals, that is to say in a quasi-continuous fashion, to the setting device (EV) 4. Using a characteristic that has been programmed in, the electronic ballast independently selects an advantageous DC component corresponding to the item of operating position information, that is to say to be inclined to the horizontal 12 by the angle α, such that the temperature difference between the electrodes of the lamp is minimized.

When the luminaire is used, for example, on a stage or in a television studio, the light beam generated by the spotlight 1 can be directed by means of the control unit 2 by rotating the spotlight 1. In this case, the quality of the light beam remains unimpaired through, for example, flickering or flicker phenomena, and the spotlight can be dimmed in all rotary positions over a wide range. Furthermore, the service life of the high pressure discharge lamp is lengthened by ₜhe temperature compensation of the electrodes, in particularly also for different operating positions.

1. A method for operating a high pressure discharge lamp with an alternating current, comprising providing the alternating current with a DC component differing from zero.

2. The method as claimed in claim 1, wherein the operating position encloses at least an angle of 10° with the horizontal.

3. The method as claimed in claim 1, wherein, the absolute value of the DC component is greater than 0.1.

4. The method as claimed in claim 1, wherein the absolute value of the DC component is greater than 0.2.

5. The method as claimed in claim 1, wherein the absolute value of the DC component is greater than 0.3.

6. The method as claimed in claim 1, wherein the absolute value of the DC component is less than 0.8.

7. The method as claimed in claim 1, wherein the absolute value of the DC component is less than 0.6.

8. The method as claimed in claim 1, wherein the absolute value of the DC component is less than 0.5.

9. The method as claimed in claim 1, wherein the angle of the operating position to the horizontal is acquired, and the absolute value of the DC component is enlarged with increasing angle.

10. An electronic ballast for a high pressure discharge lamp that is designed to operate in accordance with a method as claimed in claim 1.

11. A luminaire for a high pressure discharge lamp that has an electronic ballast as claimed in claim 10.

12. (canceled)

13. (canceled)

14. (canceled)
